(19) United States
(12) Patent Application Publication
(10) Pub. No.: US 2008/0176590 A1
(43) Pub. Date: Jul. 24, 2008

(54) METHOD AND APPARATUS FOR RECEIVING MULTIMEDIA MESSAGE SERVICE MESSAGES

(76) Inventor: Wei-Wen Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/018,212

(22) Filed: Jan. 23, 2008

(30) Foreign Application Priority Data
Jan. 23, 2007 (TW) 096102558

(51) Int. Cl. H04Q 7/20

(52) U.S. Cl. 455/466

(57) ABSTRACT

A method for a communication device, receiving MMS messages, receives an SMS message from a system service terminal. When the received SMS message is determined as a notification message related to an MMS message, the values of a first flag and a second flag are detected. When both the first and second flags are of a first value, the SMS message is sent to a message client terminal, the first flag is set to a second value, and a timer is activated. Next, the second flag is set to the second value and the MMS message is retrieved from the system service terminal. Last, the second flag is set to the first value after finishing retrieving the MMS message, and the first flag is set to the first value when the timer has expired.

### BACKGROUND OF THE INVENTION

1. Field of the Invention

The present invention relates to a method and an apparatus capable of receiving MMS messages, and more particularly, to a method and an apparatus capable of receiving MMS messages with high efficiency.

2. Description of the Prior Art

With the widespread of mobile phones and increasing competition of the associated market, products with more powerful functions are launched regularly. In order to satisfy the needs of different consumers, except for the basic function of receiving and sending phone calls, modern mobile phones also provide a variety of advanced functions, such as camera, radio, e-mail, Internet, short message service (SMS) or multimedia message service (MMS).

Among numerous advanced functions provided by mobile phones, SMS is the most commonly and frequently used service. An SMS message includes digitalized text contents characterized in mass transmission, detailed description and easy storage, and can thus be sent and received using mobile phones easily. Recently, MMS is also gaining more and more attention. Compared to SMS massages that only contain monotonous text contents and simple patterns, an MMS message includes various multi-media audio/video elements, such as texts, images, sounds, pictures and animations.

MMS messages can be transmitted via wireless application protocol (WAP) and general packet radio service (GPRS). WAP is a specification for a set of communication protocols to standardize the way that wireless devices access and interact with information and services. Any mobile phone with WAP capability can be connected to a network for wireless data transmission without using a personal computer and a wired telephone line. With a mobile phone providing high speed GPRS, the user can connect to system service terminals such as Internet, Intranet or Internet Service Providers (ISP). The user can surf the websites for instant news or information, or for downloading music, images, MMS messages or games.

Generally speaking, messages are transmitted based on WAP Push technology. The user first edits an MMS message having multi-media audio/video elements, and then transmits the MMS message to other mobile phones or e-mail addresses via data services provided by a system service provider. Reference is made to FIG. 1 for a diagram illustrating a prior art method for receiving and sending MMS messages. When a user wants to send an MMS message to a target mobile phone 14 using a mobile phone 12, the MMS message is first sent to a system service terminal 10. After receiving the MMS message, the system service terminal 10 sends an SMS notification message instead of immediately forwarding the MMS message to the target mobile phone 14. After receiving the SMS notification message, the owner of the target mobile phone 14 replies the system service terminal 10 with a confirmation message, makes a request for accessing the MMS message, and then connects to the system service terminal 10 for downloading the MMS message. After downloading the MMS message, the target mobile phone 14 replies the system service terminal 10 with a confirmation message again for completing the process of receiving the MMS message.

In the prior art method illustrated in FIG. 1, failures may occur when trying to continuously send or receive MMS messages. For example, upon receiving a first SMS notification message corresponding to a first MMS message, the target mobile phone 14 replies the system service terminal 10 with a confirmation message and prepares to retrieve the first MMS message. At this time, if the target mobile phone 14 receives a second SMS notification message corresponding to a second MMS message, the target mobile phone 14 stops retrieving the first MMS message and prepares to retrieve the second MMS message. Under these circumstances, the target mobile phone 14 cannot receive the first MMS message successfully. Therefore, the prior art method provides a low efficiency when continuously sending or receiving multiple MMS messages.

### SUMMARY OF THE INVENTION

The present invention provides a method for a communication device receiving a multimedia service (MMS) message. The communication device comprises a second timer, a first flag and a second flag. The method comprises steps of (a) determining whether a received SMS message is a notification message corresponding to the MMS message; (b) detecting values of a first flag and a second flag when the received SMS message is the notification message in (a) step; (c) sending the received SMS message to a message client device when the first flag is equal to a first value and the second flag is equal to a second value in (b) step; (d) setting the first flag to a third value and activating the second timer; (e) the message client device starting to receive the MMS message corresponding to the received SMS message; (f) setting the second flag to a fourth value; (g) setting the first flag to the first value when the second timer has expired; (h) setting the second flag to the second value after the message client device completes receiving the MMS message. Furthermore, the SMS message is queued when the first flag is equal to the third value or the second flag is equal to the fourth value. Preferably, the first and second values are equal to Boolean logic 0, and the third and fourth values are equal to Boolean logic 1.

The present invention also provides a device capable of receiving MMS messages comprising a system service terminal; a message listening device for receiving an SMS message; a mobile phone coupled to the message listening device via the system service terminal and including a first flag and a second flag; a message client device coupled to the message listening device and the mobile phone via the system service terminal and capable of determining a method for processing the SMS message based on states of the message listening device and the mobile phone; and a connecting device for establishing connection with the system service terminal based on the method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art method for receiving MMS messages.

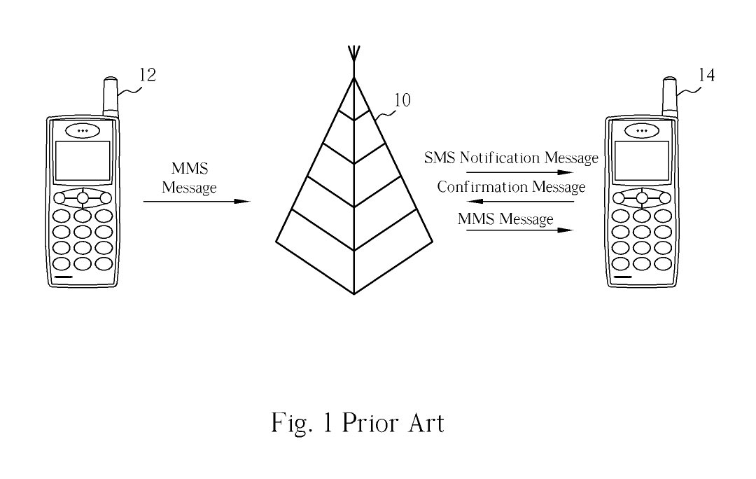

FIG. 2 is a functional diagram illustrating a mobile phone capable of receiving MMS messages according to the present invention.

FIG. 3 is a flowchart illustrating a method for receiving MMS messages according to a first embodiment of the present invention.

FIG. 4 is a flowchart illustrating a method for receiving MMS messages according to a second embodiment of the present invention.

### DETAILED DESCRIPTION

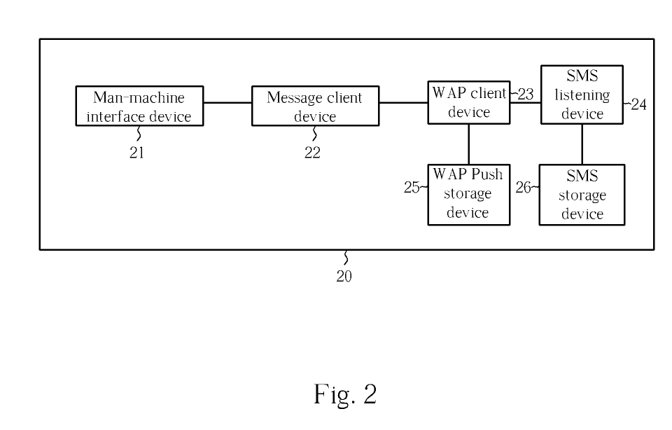

Reference is made to FIG. 2 for a functional diagram illustrating a mobile phone 20 capable of receiving MMS messages according to the present invention. The mobile phone 20 includes a man-machine interface (MMI) device 21, a message client device 22, a WAP client device 23, an SMS listening device 24, a WAP Push storage device 25, and an SMS storage device 26. Though the MMI device 21, the user can edit or read SMS/MMS messages, as well as changing the settings related to message transmission. The message client device 22 is used for processing SMS/MMS packets, decoding, encoding or displaying partial messages. The WAP client device 23 can establish network communication with the system service terminal in order to receive and send messages. The SMS listening device 24 can receive SMS messages from the system service terminal. The WAP Push storage device 25 and the SMS storage device 26 are used for storing data.

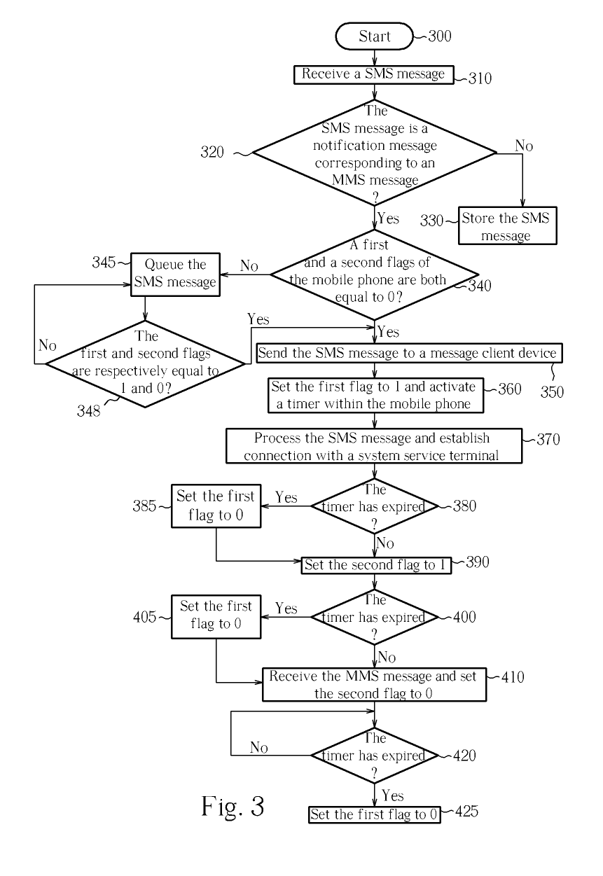

Reference is made to FIG. 3 for a flowchart illustrating a method for receiving MMS messages according to a first embodiment of the present invention. The flowchart in FIG. 3 includes the following steps:

Step 300: start.

Step 310: receive a SMS message.

Step 320: determine whether the SMS message is a notification message corresponding to an MMS message; if the SMS message is a notification message corresponding to an MMS message, execute step 340; if the SMS message is not a notification message corresponding to an MMS message, execute step 330.

Step 330: store the SMS message, and escape from current program loop.

Step 340: determine whether a first and a second flags of the mobile phone are both equal to 0; if the first and second flags are both equal to 0, execute step 350; if the first and second flags are not both equal to 0, execute step 345.

Step 345: queue the SMS message, execute step 348.

Step 348: determine whether the first and second flags are respectively equal to 1 and 0; if the first and second flags are respectively equal to 1 and 0, execute step 350; if the first and second flags are not respectively equal to 1 and 0, execute step 345.

Step 350: send the SMS message to a message client device.

Step 360: set the first flag to 1 and activate a timer within the mobile phone.

Step 370: process the SMS message and establish connection with a system service terminal.

Step 380: determine whether the timer has expired; if the timer has expired, execute step 385; if the timer has not expired, execute step 390.

Step 385: set the first flag to 0 and execute step 390.

Step 390: set the second flag to 1.

Step 400: determine whether the timer has expired; if the timer has expired, execute step 405; if the timer has not expired, execute step 410.

Step 405: set the first flag to 0 and execute step 410.

Step 410: receive the MMS message corresponding to the SMS message and set the second flag to 0 after finishing receiving the MMS message.

Step 420: determine whether the timer has expired; if the timer has expired, execute step 425; if the timer has not expired, execute step 420.

Step 425: set the first flag to 0.

In the first embodiment of the present invention, the first flag, the second flag and the timer are used for controlling the process of receiving MMS message. First, the SMS listening device 24 of the mobile phone 20 regularly checks for incoming SMS messages in step 310. A pure SMS text message and an SMS notification message corresponding to an MMS message have different formats, so the content of the received SMS message can be determined in step 320.

In step 320, when the received SMS is determined as a pure SMS message, the first embodiment of the present invention executes step 330 for storing the SMS message into the SMS storage device 26 of the mobile phone 20, so that the user can read or reply the SMS message later. When the received SMS is determined as a notification message corresponding to an MMS message, the first embodiment of the present invention executes step 340 for determining whether the first and second flags of the mobile phone are both equal to 0.

When the first flag is equal to 0, it indicates that the WAP client device 23 of the mobile phone 20 is not processing any notification message and can establish connection with the system service terminal for subsequent MMS message retrieval. When the second flag is equal to 0, it indicates that no MMS message is being retrieved via the connection between the WAP client device 23 and the system service terminal, and the connection is available for other unprocessed MMS messages.

When the first and second flags are both equal to 0, it indicates that the mobile phone 20 can process the received SMS message immediately, and step 350 is executed for sending the received SMS message to the message client device 22 of the mobile phone 20.

When at least one of the first and second flags is not equal to 0, it indicates that (1) the WAP client device 23 of the mobile phone 20 is processing certain notification message, and can not immediately establish connection with the system service terminal, or (2) the current task performed via the connection between the WAP client device 23 and the system service terminal is still on-going. Under these circumstances, step 345 is executed for queuing the received SMS message. In other words, the received SMS message is stored into the WAP Push storage device 25 of the mobile phone 20.

In the first embodiment, the step 348 is executed for determining whether the first and second flags are respectively equal to 1 and 0. When the first and second flags are respectively equal to 1 and 0, step 350 is executed for sending the queued SMS message to the message client device 22 of the mobile phone 20; when the first and second flags are not respectively equal to 1 and 0, step 345 is executed for continuing to queue the SMS message.

After the message client device 22 receives the SMS message, step 360 is executed for setting the first flag to 1 and activating the timer, and step 370 is executed for processing the SMS message and establishing connection with the system service terminal. When the first flag is equal to 1 and the SMS listening device 24 simultaneously receives another new SMS message, the newly received SMS message will be sent to the queue as step 345, and will not be immediately sent to the message client device 22. Therefore, the present invention can prevent the new SMS message from replacing or influencing the original SMS message currently being processed.

Next, the message client device 22 now is standby to receive the MMS message corresponding to the SMS message from the system service terminal, so the second flag is set to 1 in step 390, indicating that the connection between the WAP client device 23 and the system service terminal is currently processing the MMS message and cannot be interrupted. As a result, if the SMS listening device 24 receives another new SMS message when the second flag is 1, the step 345 is executed for queuing the new SMS message instead of immediately sending the new SMS message to the message client device 22. Therefore, the new SMS message will not influence the process of receiving the MMS message corresponding to the original SMS message.

Next, the message client device 22 begins to receive the MMS message corresponding to the SMS message in step 410. After completing the process of receiving the MMS message, the second flag is set to 0 for indicating that the connection between the WAP client device 23 and the system service terminal is now available for the next MMS message.

Meanwhile, while executing steps 370 through 410 for processing the SMS message, establishing connection with the system service terminal and receiving the MMS message, the present invention constantly checks whether the timer has expired (steps 380 and 400). In the mobile phone 20, the MMI device 21 and the WAP client device 23 belong to different tasks, so the data exchanged between both processes sometimes may get lost. Therefore, the first embodiment uses the timer to control the maximum time period for processing single SMS message. Therefore, it can avoid the situation that the connection is occupied forever due to data loss between different tasks. The expiration time of the timer is set based on the estimated time required for the MMI device 21 to process single SMS message. When the timer has expired, the first flag is set to 0.

In the first embodiment of the present invention, the path for transmitting messages is blocked when the first and second flags are both equal to 1, and messages are transmitted when the first and second flags are both equal to 0. However, the present invention can use other methods for controlling the message transmission path. For example, the path for transmitting messages can be blocked when the first and second flags are both equal to 0, and messages can be transmitted when the first and second flags are both equal to 1. Therefore, the method for determining the values of the first and second flags in the first embodiment only illustrates but does not limit the scope of the present invention.

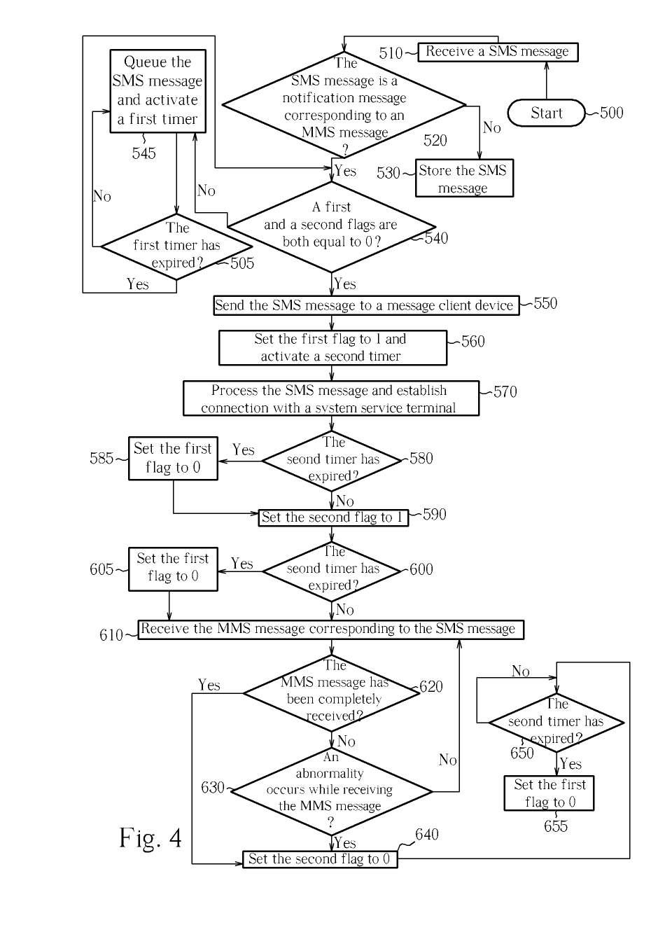

Reference is made to FIG. 4 for a flowchart illustrating a method for receiving MMS messages according to a second embodiment of the present invention. The flowchart in FIG. 4 includes the following steps:

Step 500: start.

Step 510: receive a SMS message.

Step 520: determine whether the SMS message is a notification message corresponding to an MMS message; if the SMS message is a notification message corresponding to an MMS message, execute step 540; if the SMS message is not a notification message corresponding to an MMS message, execute step 530.

Step 530: store the SMS message, and escape from current program loop.

Step 540: determine whether a first and a second flags are both equal to 0; if the first and second flags are both equal to 0, execute step 550; if at least one of the first and second flags is 1, execute step 545.

Step 545: queue the SMS message and activate a first timer, and then execute step 505.

Step 505: determine whether the first timer has expired; if the first timer has expired, execute step 540; if the first timer has not expired, execute step 545.

Step 550: send the SMS message to a message client device.

Step 560: set the first flag to 1 and activate a second timer.

Step 570: process the SMS message and establish communication with a system service terminal.

Step 580: determine whether the second timer has expired; if the second timer has expired, execute step 585; if the second timer has not expired, execute step 590.

Step 585: set the first flag to 0 and execute step 590.

Step 590: set the second flag to 1.

Step 600: determine whether the second timer has expired; if the second timer has expired, execute step 605; if the second timer has not expired, execute step 610.

Step 605: set the first flag to 0 and execute step 610.

Step 610: receive the MMS message corresponding to the SMS message.

Step 620: determine whether the MMS message has been completely received; if the MMS message has been completely received, execute step 640; if the MMS message has not been completely received, execute step 630.

Step 630: determine whether an abnormality occurs while receiving the MMS message; if an error occurs while receiving the MMS message, execute step 640; if no error occur while receiving the MMS message, execute step 610.

Step 640: set the second flag to 0 and then execute step 650.

Step 650: determine whether the second timer has expired; if the second timer has expired, execute step 655; if the second timer has not expired, execute step 650.

Step 655: set the first flag to 0.

The second embodiment differs from the first embodiment of the present invention in that two timers and two flags are used for controlling the process of receiving MMS messages. Upon receiving multiple SMS messages, the SMS listening device 24 of the mobile phone 20 can only receive and process each SMS message sequentially.

Therefore, the second embodiment of the present invention can set the expiration time of the first timer based on the time required for receiving a message. When receiving a new SMS message corresponding to a notification message of a MMS message, and simultaneously at least one of the first and second flags is not equal to 0, then the step 545 is executed for queuing the new SMS message and activating the first timer. When the first timer is found expired in step 505, then the step 540 is executed once more to periodically check whether the first and second flags are both equal to 0.

Steps 550, 560 and 570 are respectively executed in the same way as step 350, 360 and 370 and the detailed operations thereof are omitted here. The steps 580 and 600 determine whether the second timer expires so as to prevent the connection from being occupied forever due to data loss among different circuit blocks.

Also, after beginning to receive the MMS message in step 610, step 630 is executed for determining whether an abnormality occurs while receiving the MMS message. An abnormality can be caused by the following situations:

(1) An error occurs when the message client device 22 sends a confirmation message to the WAP client device 23 for receiving the MMS message.

(2) The message client device 22 encounters an error due to unknown reasons and thus breaks off current operations.

(3) The WAP client device 23 encounters an error during the process of receiving the MMS message and thus breaks off the connection with the system service terminal.

When the MMS message has not been completely received or an abnormality occurs while receiving the MMS message, the second embodiment of the present invention executes step 640 for setting the second flag to 0, thereby indicating that the connection between the WAP client device 23 and the system service terminal can be interrupted. When the MMS message has not been completely received but no abnormality occurs while receiving the MMS message, the second embodiment of the present invention executes step 610 for continuing to receive the MMS message. After the MMS message has been completely received, the second embodiment of the present invention executes step 640 for setting the second flag to 0, thereby indicating that the connection between the WAP client device 23 and the system service terminal can be interrupted.

In the second embodiment of the present invention, the path for transmitting messages is blocked when the first and second flags are both equal to 1, and messages are transmitted when the first and second flags are both equal to 0. However, the present invention can use other methods for controlling the message transmission path. For example, the path for transmitting messages can be blocked when the first and second flags are both equal to 0, and messages can be transmitted when the first and second flags are both equal to 1. Therefore, the method for determining the values of the first and second flags in the second embodiment only illustrates but does not limit the scope of the present invention.

The present invention controls the process of receiving MMS messages by using timers and flags instead of counting on complicated logic calculations or massive data storage. Multiple MMS messages can be received sequentially without influencing the message which is currently being retrieved. Therefore, the present invention can increase the efficiency and success rate when receiving MMS messages.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a communication device receiving a multimedia service (MMS) message, the communication device comprising a second timer, a first flag and a second flag, the method comprising steps of:
(a) determining whether a received SMS message is a notification message corresponding to the MMS message;
(b) detecting values of a first flag and a second flag when the received SMS message is the notification message in (a) step;
(c) sending the received SMS message to a message client device when the first flag is equal to a first value and the second flag is equal to a second value in (b) step;
(d) setting the first flag to a third value and activating the second timer;
(e) the message client device starting to receive the MMS message corresponding to the received SMS message;
(f) setting the second flag to a fourth value;
(g) setting the first flag to the first value when the second timer has expired; and
(h) setting the second flag to the second value after the message client device completes receiving the MMS message.

2. The method of claim 1 further comprising step of:
(c′) queuing the SMS message when the first flag is equal to the third value in (b) step.

3. The method of claim 1 further comprising step of:
(c′) queuing the SMS message when the second flag is equal to the fourth value in (b) step.

4. The method of claim 1 further comprising step of:
the message client device processing the SMS message and establishing connection with the system service terminal for receiving the MMS message.

5. The method of claim 2 wherein the communication device further comprising a first timer, and the method further comprising step of:
when the SMS message is in queue, performing (b) step once when the first timer expired.

6. The method of claim 3 wherein the communication device further comprising a first timer, and the method further comprising step of:
when the SMS message is in queue, performing (b) step once when the first timer expired.

7. The method of claim 1 wherein the first and second values are equal to Boolean logic 0, and the third and fourth values are equal to Boolean logic 1.

8. An apparatus capable of receiving MMS messages comprising:
a system service terminal;
a message listening device for receiving an SMS message;
a mobile phone coupled to the message listening device via the system service terminal and including a first flag and a second flag;
a message client device coupled to the message listening device and the mobile phone via the system service terminal and capable of determining a method for processing the SMS message based on states of the message listening device and the mobile phone; and
a connecting device for establishing connection with the system service terminal based on the method.

9. The apparatus of claim 8 further comprising:
a storage device for storing the SMS message.

10. The apparatus of claim 8 wherein the mobile phone further comprises:
a first timer for setting the first flag.

11. The apparatus of claim 8 wherein the mobile phone further comprises:
a second timer, based on which the message client device checks for SMS messages regularly.

12. The apparatus of claim 8 further comprising:
a man-machine interface (MMI) device for editing or reading received messages, or for changing settings related to receiving and sending messages.
